(19) United States
(12) Patent Application Publication
(10) Pub. No.: US 2008/0003369 A1
(43) Pub. Date: Jan. 3, 2008

(54) Low Shrinking Amine-Curing Epoxy Compositions

(76) Inventors: Kazuya Uenishi, Nara (JP); Masashi Horikiri, Kanagawa (JP); Atsushi Sudo, Tokyo (JP); Takeshi Endo, Yokohama (JP)

Correspondence Address: HENKEL CORPORATION, 1001 TROUT BROOK CROSSING, ROCKY HILL, CT, 06067, US

(21) Appl. No.: 11/780,170

(22) Filed: Jul. 19, 2007

Related U.S. Application Data
(63) Continuation of application No. PCT/EP2006/000982, filed on Feb. 4, 2006.

(30) Foreign Application Priority Data
Feb. 18, 2005 (EP) 05003513.8

(51) Int. Cl. C09J 163/00; B05D 3/02

(52) U.S. Cl. 427/386; 156/330; 427/372.2; 427/384

(57) ABSTRACT

The present invention relates to the use of one or more 6-membered lactones condensed to an aromatic or heteroaromatic moiety as shrinkage-suppressing agents in amine-curing epoxy compositions, such compositions and the use of such compositions in adhesives, sealants and coatings.

### CROSS-REFERENCE TO RELATED APPLICATIONS

This application is a continuation under 35 USC Sections 365(c) and 120 of International Application No. PCT/EP2006/000982, filed 4 Feb., 2006 and published 24 Aug., 2006 in English as WO 2006/087111, which claims priority from European Application No. 05003513.8 filed 18 Feb., 2005, each of which is incorporated herein by reference in its entirety.

### FIELD OF THE INVENTION

The present invention relates to the use of 6-membered aromatic lactones to reduce shrinkage of amine-cured epoxy compositions and compositions containing such lactones.

### BRIEF DESCRIPTION OF THE STATE OF THE TECHNOLOGY

Compositions containing amine-type-hardeners, such as tertiary amines or imidazole-type amines, are frequently used or at least considered in semiconductor package and assembly applications, such as flip chip and chip scale package underfills.

However, these compositions suffer from their volume shrinkage during curing reactions, up to levels as high as 4% shrinkage. The volume shrinkage during the curing reaction causes the formation of voids and micro-cracks in the cured material, and thus results in lowering the mechanical strength of the material. Especially in such semiconductor package and assembly applications, shrinkage causes contact failure between the adhesive and the substrate, thus leading to adhesion failure. More importantly, however, moisture can reach the surface of the substrate through voids and cracks, damaging the semiconductor chip and other components.

The problem of volume shrinkage has been conventionally solved by the addition of inorganic fillers. However, addition of fillers to curable compositions frequently results in an increase in viscosity and thus reduces fluidity. Such viscosity increase can affect dispensing of the compositions. And some fillers have abrasive qualities, which may adversely affect the surface of the semiconductor chip and/or circuit board or carrier substrate to which the semiconductor is to be attached. Moreover, the addition of fillers may affect certain physical properties of the cured composition, such as by decreasing mechanical strength and consequently adhesion strength.

One proposed solution to the problem of volume shrinkage has been the addition of shrinkage suppressive monomers as co-monomers in the composition. However, most of the shrinkage suppressive monomers are not suitable for amine-catalyzed curing reactions of epoxy monomers, because they do not react randomly under conventional reaction conditions or they decompose under those reaction conditions.

Japanese Patent Document No. JP 2003-238659 (“JP '659”) describes the addition of a lactone to an epoxy resin in the presence of a tertiary amine to control an early elevation in viscosity.

Japanese Patent Document No. JP11-158350 (“JP '350”) discloses a composition similar to that described in JP '659, and its use as an electronic chip bonder. The purpose of the addition of the lactone here appears to be to control viscosity, suppress reactivity and provide a longer pot life.

Despite JP '659 and JP '350 there remains a need to combat volume shrinkage in amine-cured epoxy compositions.

### BRIEF SUMMARY OF THE INVENTION

The inventors have studied the influence of a variety of lactones on the copolymerization of epoxides in the presence of amines, and found that most of the lactones studied did not undergo random copolymerization with epoxide monomers and did not show any sufficient shrinkage-suppression effect.

Therefore the inventors found it highly surprising that 6-membered (hetero)aromatic lactones undergo random copolymerization with epoxides effectively and were able to provide amine-curing epoxy compositions with the desired shrinkage-suppression effect.

### BRIEF DESCRIPTION OF THE DRAWING

FIG. 1 shows the differential scanning calorimetric profiles (DSC profiles) for the curing reactions of the formulations used in certain of the Examples.

### DETAILED DESCRIPTION OF CERTAIN EMBODIMENTS OF THE INVENTION

To overcome the volume-shrinkage problems of amine-curing epoxy formulations, at least one lactone compound comprising a 6-membered lactone ring, such as a 6-membered lactone condensed to an aromatic or heteroaromatic moiety, has been added to compositions containing an epoxy resin and an amine curative to act as shrinkage-suppressing agent.

These 6-membered lactones condensed to an aromatic or heteroaromatic moiety are referred to as “Lactones (I)”.

Preferably the aromatic or heteroaromatic moiety of lactones (I) according to the present invention is a 5- to 7-membered, more preferably a 6-membered aromatic or heteroaromatic ring, wherein the hetero atom or hetero atoms in the heteroaromatic ring are preferably selected from nitrogen, oxygen and/or sulfur.

6-membered lactone moieties may also be condensed to neighboring carbon atoms of the aromatic or heteroaromatic moiety, building bifunctional lactones such as e.g. the bifunctional lactone “BL”. See Marx. J. N. et al., J. Heterocyclic Chem., 12(2), 417 (1975).

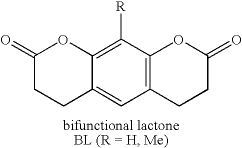

Examples of 5-membered aromatic or 5-membered heteroaromatic moieties condensed to the 6-membered lactone moiety include for instance the furan moiety, the thiophene moiety or the pyrrole moiety.

Examples of 6-membered aromatic or 6-membered heteroaromatic moieties condensed to the 6-membered lactone moiety include for instance the benzene moiety or the pyridine moiety. Particularly preferred is the benzene moiety.

The aromatic or heteroaromatic moieties as well as the 6-membered lactone moiety itself can be further substituted by one or more straight chain or branched alkyl groups having 1 to 20 carbon atoms, preferably 1 to 12, most preferably 1 to 6 carbon atoms, like e.g. methyl, ethyl or propyl groups. Further substituents may be chosen from hydroxy, aryl, alkaryl or aralkyl groups, with preferably 6 to 20 carbon atoms, which can be directly bound to the aromatic or heteroaromatic moieties or 6-membered lactone moiety, or which can also be bound to those moieties by bridging atoms or bridging groups, like —O—, —S—, —(CO)—, —O—(CO)— or —(CO)—O—.

Most preferable lactones (I) are those condensed to a benzene moiety as the aromatic moiety, and can be described by the following general formula: 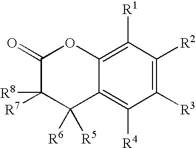
where R¹, R², R³, R⁴, R⁵, R⁶, R⁷ and R⁸ are independently same or different and denote
hydrogen; hydroxyl;
a straight chain or branched alkyl group having 1 to 20 carbon atoms, preferably 1 to 12, most preferably 1 to 6 carbon atoms, like e.g. methyl, ethyl or propyl groups;
aryl, alkaryl or aralkyl groups, with preferably 6 to 20 carbon atoms, which can be directly bound to the aromatic or heteroaromatic moieties or 6-membered lactone moiety, or which can also be bound to those moieties by bridging atoms or bridging groups, like e.g. —O—, —S—, —(CO)—, —O—(CO)— or —(CO)—O—; and/or
neighboring residues;
R¹ and R²; or R² and R³; or R³ and R⁴ form 6-membered lactone moieties.

Such compounds can be understood as dihydrocoumarins, whereby this term includes dihydrocoumarin itself and its derivatives.

Most preferably R⁵, R⁶, R⁷ and R⁸ are hydrogen.

Further, any one of residues R¹, R², R³ or R⁴ may serve as an aliphatic, cycloaliphatic or aromatic “bridging group” to another lactone (I), as exemplified for residue R² below:

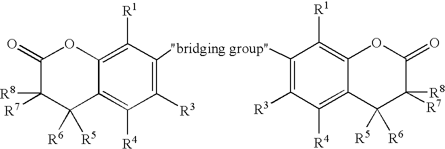

Examples for bridging groups include -alkylene-, -phenylene-, —O-alkylene-O—, —O-phenylene-O—, —O—CO-alkylene-CO—O—, —O—CO-phenylene-CO—O—, —O—CO—NH-alkylene-NH—CO—O—, or —O—CO—NH-phenylene-NH—CO—O— groups, whereby any of the alkylene or phenylene groups can be further substituted, preferably by alkyl groups with 1 to 4 carbon atoms.

Scheme 1 shows only a few of a variety of possible structures of suitable lactones (I).

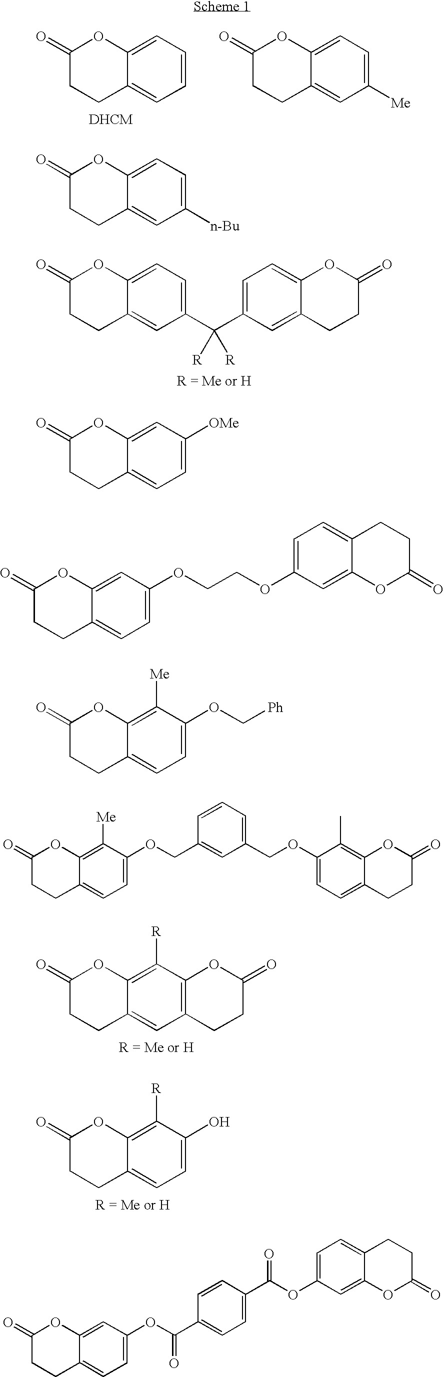

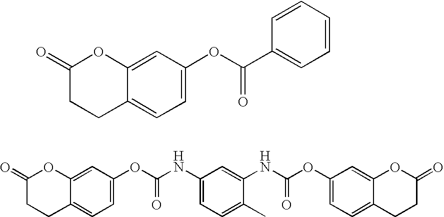

Amine-Curing Epoxy Compositions

The invention further provides amine-curing epoxy compositions that comprise besides the lactone component at least one epoxy component (II), and at least one amine curative or hardener (III).

The lactone component undergoes copolymerization with the epoxy component (II) in the presence of the amine-type hardener (III) by way of exposure to elevated temperature conditions as described below.

The invention is not limited to any specific epoxy component. In general all epoxy components used in amine-hardening epoxy compositions are suitable to be used in the compositions of the present invention.

Preferable examples of suitable epoxy components (II) are any common epoxy resin, a portion of which is a multifunctional epoxy resin, i.e. an epoxy resin with more than one, for instance two or more epoxy groups.

Examples of such epoxy resins include C₄-C₂₈ alkyl glycidyl ethers; C₂-C₂₈ alkyl- and alkenyl-glycidyl esters; C₁-C₂₈ alkyl-, mono- and poly-phenol glycidyl ethers; polyglycidyl ethers of pyrocatechol, resorcinol, hydroquinone, 4,4′-dihydroxydiphenyl methane (or bisphenol F, such as RE-404-S or RE-410-S available commercially from Nippon Kayuku, Japan), 4,4′-dihydroxy-3,3′-dimethyidiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris(4-hydroxyphyenyl)methane; polyglycidyl ethers of transition metal complex chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogen dialkyl ether; polyglycidyl ethers of polyphenols obtained by condensing phenols and long-chain halogen paraffins containing at least two halogen atoms; N,N′-diglycidyl-aniline; N,N′-dimethyl-N,N′-diglycidyl-4,4′-diaminodiphenyl methane; N,N,N′,N′-tetraglycidyl-4,4′-diaminodiphenyl methane; N,N′-diglycidyl-4-aminophenyl glycidyl ether; N,N,N′,N′-tetraglycidyl-1,3-propylene bis-4-aminobenzoate; phenol novolac epoxy resin; cresol novolac epoxy resin; and combinations thereof.

Among the commercially available epoxy resins suitable for use herein are polyglycidyl derivatives of phenolic compounds, such as those available under the tradenames EPON 828, EPON 1001, EPON 1009, and EPON 1031, from Shell Chemical Co.; DER 331, DER 332, DER 334, and DER 542 from Dow Chemical Co.; GY285 from Ciba Specialty Chemicals, Tarrytown, N.Y.; and BREN-S from Nippon Kayaku, Japan. Other suitable epoxy resins include polyepoxides prepared from polyols and the like and polyglycidyl derivatives of phenol-formaldehyde novolacs, the latter of which are available commercially under the tradenames DEN 431, DEN 438, and DEN 439 from Dow Chemical Company. Cresol analogs are also available commercially ECN 1235, ECN 1273, and ECN 1299 from Ciba Specialty Chemicals. SU-8 is a bisphenol A-type epoxy novolac available from Shell Chemicals (formerly, Interez, Inc.). Polyglycidyl adducts of amines, aminoalcohols and polycarboxylic acids are also useful in this invention, commercially available resins of which include GLYAMINE 135, GLYAMINE 125, and GLYAMINE 115 from F.I.C. Corporation; ARALDITE MY-720, ARALDITE MY-721, ARALDITE 0500, and ARALDITE 0510 from Ciba Specialty Chemicals and PGA-X and PGA-C from the Sherwin-Williams Co. And of course combinations of the different epoxy resins are also desirable for use herein.

As noted above, the epoxy resin component of the present invention preferably includes any common epoxy resin, at least a portion of which is a multifunctional epoxy resin. Ordinarily, the multifunctional epoxy resin should be included in an amount within the range of preferably about 20 weight percent to preferably about 100 weight percent of the epoxy resin component.

A monofunctional epoxy resin, if present, should ordinarily be used as a reactive diluent, or crosslink density modifier. In the event such a monofunctional epoxy resin is included as a portion of the epoxy resin component, such resin should be employed in an amount of preferably up to about 20 weight percent, based on the total epoxy resin component.

Preferable epoxy compounds (II), can be exemplified by the following general formula: 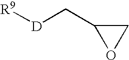
where D denotes an oxygen or 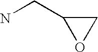
and R⁹ is selected from the group consisting of a straight-chain or branched alkyl group with 1 to 18 carbon atoms; an aromatic or heteroaromatic group with 4 to 12 carbon atoms; a group with the structure 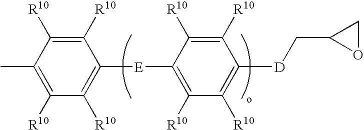
where all R¹⁰ within the group are same or different and independently denote hydrogen or an alkyl group with 1 to 4 carbon atoms,
and o is 0 or 1,
and E is selected from a carbon-carbon single bond and CR¹¹₂ wherein R¹¹ is same or different and independently denotes hydrogen or an alkyl group with 1 to 4 carbon atoms; and D is defined as above, or
R⁹ is a group with the structure R¹²—SiR¹³R¹⁴R¹⁵
where R¹³ and R¹⁴ are the same or different, each of which denotes a straight-chain or branched alkoxy residue with 1 to 6 carbon atoms or an aryloxy or aralkyloxy residue,
R¹⁵ is different or the same as R¹³ or R¹⁴ or an aliphatic residue, an amino residue, a halogen residue, an aromatic or heteroaromatic residue, or an araliphatic or heteroaraliphatic residue,
R¹² is a bridging group selected from aliphatic, heteroaliphatic, araliphatic, heteroaraliphatic, aromatic and heteroaromatic groups.

Preferably R¹³, R¹⁴ and R¹⁵ are the same or different, and each independently denotes a straight-chain or branched alkoxy residue with 1 to 4 carbon atoms, most preferably a methoxy or ethoxy residue. R¹² is preferably an alkylene chain with 1 to 6 carbon atoms, more preferably 2 to 4 carbon atoms, and most preferably a propylene group.

In case R⁹ is a group with the structure R¹²—SiR¹³R¹⁴R¹⁵, at least two residues selected from R¹³, R¹⁴ and R¹⁵ are apt to hydrolyze upon contact with moisture and therefore may form polycondensates.

Examples of such compounds are shown in Scheme 2. Oligomers of these compounds having residual epoxide groups, e.g., oligomers prepared by thermal or ionic oligomerization, by addition reaction with thiol, by addition reaction with carboxylic acid, by addition with carboxylic anhydride, and by addition reaction with amine, can be similarly used.

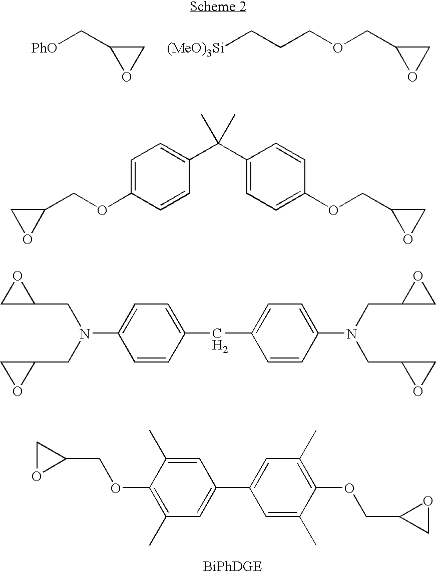

There is no restriction in the structure of the suitable amines, and even mixtures of two and more amino compounds can be used. Preferably amine-type hardeners are selected from primary amines, secondary amines and amine catalysts comprising tertiary amines, aromatic amines and heteroaromatic amines.

(1) When the amine-type hardener is an aromatic or heteroaromatic amine, like an imidazole or imidazole derivative (III a) (like an alkylated imidazole), or a tertiary amine (III b) (e.g. a heterocyclic tertiary amine), it can be used as a catalyst that promotes anionic co-polymerization of epoxide and lactone. R¹⁶, R¹⁷, R¹⁸ and R¹⁹ denotes aliphatic or aromatic hydrocarbons. Only R¹⁹ can also be a hydrogen atom.

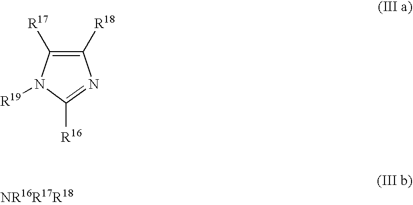

In the following only a few more compounds are exemplified. Examples are triethylamine, dimethyl benzylamine, 2,4,6-tris(dimethyl aminomethyl)phenol, pyridine, 4-dimethylaminopyridine, 3-dimethylaminopropylamine, 3-diethylaminopropylamine, 3-dibutylaminopropylamine, 2-diethylamino ethylamine, 1-diethylamino-4-aminopentane, N-(3-aminopropyl)-N-methyl propanediamine, 1-(2-aminoethyl)piperazine, 3-(3-dimethylaminopropyl) propylamine, 4-(2-aminoethyl)morpholine, 4-(3-aminopropyl) morpholine, or an imidazole derivative, as e.g. imidazole, 2-methylimidazole, 2-ethylimidazole, 2-undecylimidazole, 2-heptadecylimidazole, 2-phenylimidazole, 1,2-dimethyl imidazole, 2-ethyl-4-methylimidazole, 2-phenyl-4-methylimidazole, 1-benzyl-2-phenylimidazole, 1-benzyl-2-methylimidazole, 1-cyanoethyl-2-methylimidazole or 1-aminoethyl-2-methylimidazole.

Only some of those amine-curing catalysts are shown in Scheme 3.

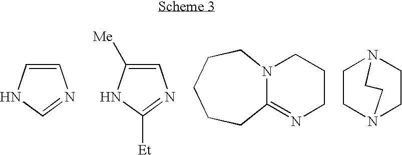

(2) When the amine-type hardener is a primary amine or a secondary amine, it can be used as a stoichiometric hardener, i.e., it is not a catalyst, but its amino groups react with epoxides or lactones to form covalent bonds.

Preferable examples for suitable primary amines are e.g. the so-called Jeffamines®, which are polyoxyalkyleneamines. They contain primary amino groups attached to the terminus of a polyether backbone. They are thus “polyether amines”. The polyether backbone is based either on propylene oxide (PO), ethylene oxide (EO), or mixed EO/PO. The Jeffamines® comprise monoamines, diamines, and triamines, which are available in a variety of molecular weights.

The most suitable primary amines are:

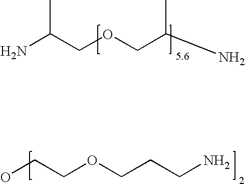

Such amines can also be used in adduct forms, such as epoxy adducts, isocyanate adducts, and carboxylic acid adducts (=amide amine).

When the amine-type hardener is an imidazole- or tertiary amine-type catalyst, the ratio of [epoxy groups (mol)]:[amine catalyst (mol)] is preferably from 99.9:0.1 to 80:20, more preferably 99:1 to 90:10. In the case the ratio is higher, curing proceeds insufficiently and unreacted epoxy resin may remain in the resulting cured material. In case the ratio is lower, the polymerization degree of the epoxide may be decreased and the resulting cured material may possess insufficient mechanical strength to be applied as a coating, sealant, or adhesive.

When the amine-type hardener is a primary or secondary amine, the ratio of [epoxy groups (mol)]:[active hydrogen in primary and/or secondary amine groups (mol)] is preferably from 90:10 to 30:70, more preferably 75:25 to 50:50. Out of these ranges, crosslinking reaction may insufficiently proceed, and thus the resulting cured resin may not have enough mechanical strength to be applied as a coating, sealant, or adhesive.

The ratio of [epoxy groups (mol)]:[lactone groups (mol)] is preferably from 99:1 to 30:70, more preferably 95:5 to 60:40. In case the ratio is higher, the shrinkage suppression effect may be negligible. In case the ratio is lower, the lactone group may not be completely consumed and may remain intact in the resulting cured resin, lowering its mechanical strength.

When the amine-type hardener is an imidazole- or tertiary amine-type catalyst, the curing reaction may be carried out at a temperature in the range of 60° C. to 250° C., more preferably in the range of 100° C. to 200° C.

When the amine-type hardener is a primary or secondary amine, the curing reaction is preferably carried out at a temperature in the range of 0° C. to 200° C., more preferably in the range of 20° C. to 150° C.

The present invention further provides the use of the compositions of the present invention in or as for instance sealants, adhesives and coatings.

Suitable substrates on which the compositions can be applied are metals such as steel, aluminum, titanium, magnesium, brass, stainless steel, galvanized steel, like HDG-steel and EG-steel; silicates such as glass and quartz; metal oxides; concrete; wood; electronic chip material, for instance semiconductor chip material; or polymers such as polyimide films and polycarbonate.

The present invention is exemplified in more detail by means of Examples, which follow below.

### EXAMPLES

The following abbreviations for the substances used in the examples and comparative examples will be used:

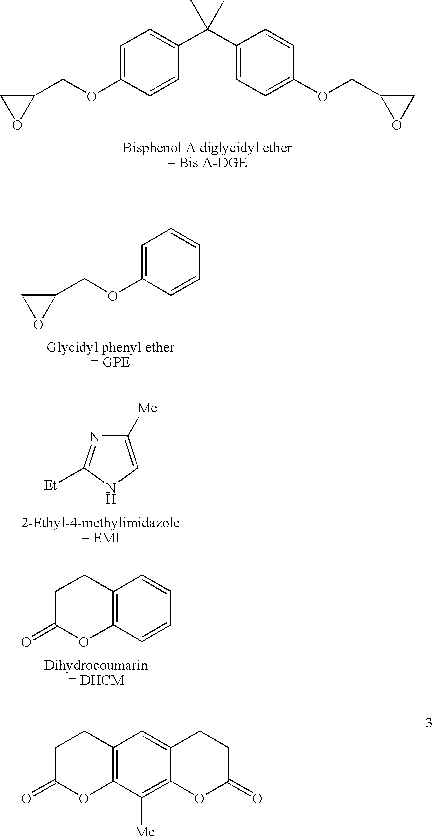

### Example 1-1

### Formulation: Bis A-DGE+DHCM+EMI

Preparation of the Curable Formulation

Bis-A-DGE (34.0 g, 100 mmol, amount of epoxy group=200 mmol), DHCM (5.23 g, 35.2 mmol) and EMI (1.28 g, 11.8 mmol) were mixed and degassed under vacuum to obtain the corresponding homogeneous liquid A. The ratio [epoxy group]:[lactone group]:[EMI]=85:15:5.

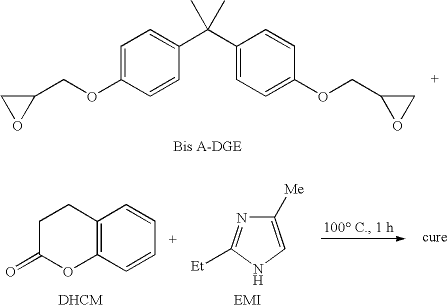

Curing Reaction and Shrinkage Test

Approximately 5 g of the obtained mixture A was used to measure its volume by gas-pycnometer. From the weight and the volume of the sample, its density before curing (=D_{before curing}) was calculated. Three independent samples were used for the test, and each sample was tested 5 times to calculate the average density (D_{before curing}). The density values ranged from 1.1619 g/cm³ to 1.1627 g/cm³ (average=1.1623 g/cm³). Then, the mixture was transferred into a silicone mold, and was cured at 100° C.-150° C. for 1 h, to obtain a cylinder-shaped cured resin, of which average density (D_{after curing}; average of 15 times measurement) was measured by gas-pycnometer. Based on the two density values, the degree of volume change was calculated to be 2.1-2.3%, according to the equation:
Degree of volume change [%]=[(D_{before curing})/(D_{after curing})−1]×100

Adhesion Testing

For adhesion testing, the adhesive composition was applied on a steel specimen and was cured at 100° C. for 1 h. The lapshear strength was 20.8 N/mm².

The test was carried out according to the ASTM D1002 Apparent Shear Strength of Single-Lap-Joint Adhesively Bonded Metal Specimens by Tension Loading (Metal-to-Metal) making use of a tension testing machine (Model: 4204, manufactured by INSTRON, U.S.A.). The specimens used were grid blasted mild steel lapshear specimens (25.4×101.6×1.6 mm (TS101)). The test was carried out at 23° C. and 50% relative humidity (RH).

### Example 1-2

### Formulation: Bis A-DGE+DHCM-OH+EMI

Instead of DHCM, DHCM-OH was used. The ratio [epoxy group]:[DHCM-OH]:[EMI]=85:15:5. The corresponding tests were those carried out for the Example 1-1.

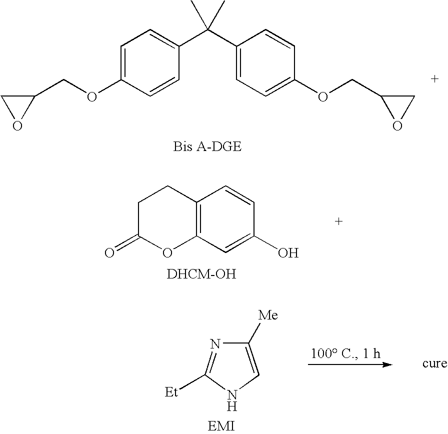

### Example 1-3

### Formulation: Bis A-DGE+DHCM-OBn+EMI

The example was carried out like Example 1-1 with the following differences: Instead of DHCM, DHCM-OBn was used. Molar ratio [epoxy group]:[DHCM-OBn]:[EMI]=85:15:5. The corresponding tests were those carried out for the Example 1-1. The corresponding data are listed in Table 1.

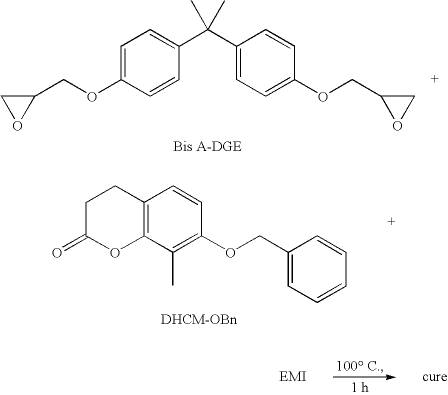

### Example 1-4

### Formulation: Bis A-DGE+p-Me-DHCM+EMI

The example was carried out like Example 1-1 with the following differences: Instead of DHCM, p-Me-DHCM was used. Molar ratio [epoxy group]:[p-Me-DHCM]:[EMI]=85:15:5. The corresponding tests were those carried out for the Example 1-1. The corresponding data are listed in Table 1.

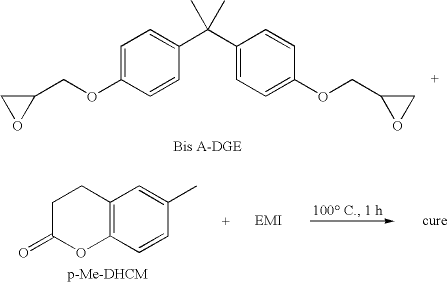

### Comparative Example 1-1

### Formulation: Bis A-DGE+ε-caprolactone+EMI

Instead of DHCM-chemistry, the monofunctional lactone 8-caprolactone (CL) was used. The ratio [epoxy group]:[CL]:[EMI]=85:15:5.

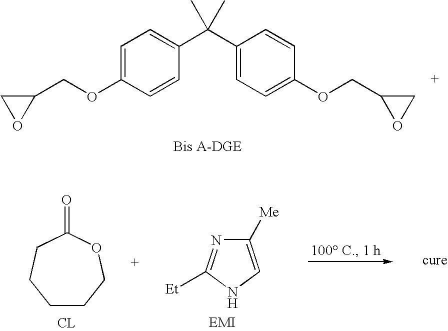

### Comparative Example 1-2

### Formulation: Bis A-DGE+ε-valerolactone+EMI

Instead of DHCM-chemistry, the monofunctional lactone ε-valerolactone (VL) was used. The ratio [epoxy group]:[VL]:[EMI]=85:15:5.

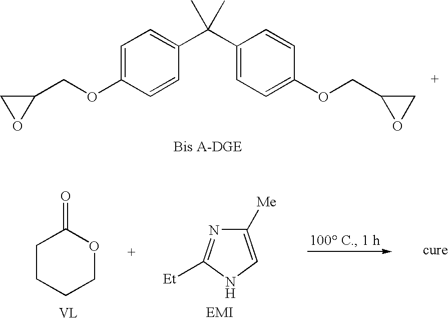

### Comparative Example 1-3

### Formulation: Bis A-DGE+GPE+EMI

Instead of DHCM-chemistry, the monofunctional epoxide GPE was used. The ratio [epoxy group of Bis A-DGE]:[epoxy group of GPE]:[EMI]=85:15:5.

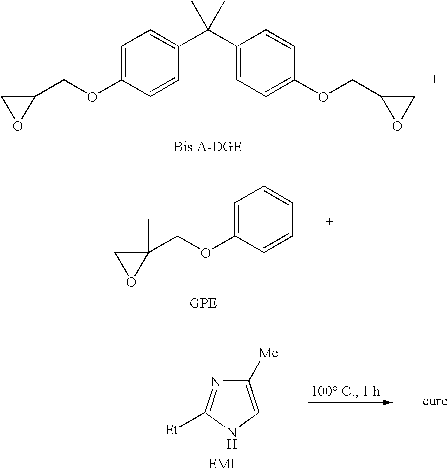

The data for Example 1-1 and 1-2, and Comparative Examples 1-1, 1-2 and 1-3 are shown in Table 1. The data for Example 1-3 and 1-4 are shown in Table 1-2.

TABLE 1
Properties of the curable formulations (cured at 100° C. for 1 h)

| | | | Comp. Ex. | Comp. Ex. | Comp. Ex. |
|---|---|---|---|---|---|
| | Example 1-1 | Example 1-2 | 1-1 | 1-2 | 1-3 |
| D_{before} (g/mL) | 1.159 | 1.181 | 1.142 | 1.152 | 1.148 |
| D_{after} (g/mL) | 1.187 | 1.205 | 1.175 | 1.186 | 1.186 |
| volume | 2.4 | 2.0 | 2.9 | 3.0 | 3.3 |
| shrinkage (%) | | | | | |
| Td₁₀ | 410° C. | 406° C. | | | 413° C. |
| Tg | 137° C. | 154° C. | | | 119° C. |
| Adhesion strength | 20.8-21.8 MPa | | | | 11.1-1 3.7 MPa |

TABLE 1-2
Properties of the curable formulations (cured at 100° C. for 1 h)

| | Example 1-3 | Example 1-4 |
|---|---|---|
| D_{before} (g/mL) | 1.169 | 1.169 |
| D_{after} (g/mL) | 1.193 | 1.195 |
| volume | 2.1 | 2.2 |
| shrinkage (%) | | |
| Td₁₀ | 404° C. | 410° C. |
| Tg | 129° C. | 115° C. |

Examples 1-1 and 1-2, making use of DHCM-chemistry, show very good results concerning volume shrinkage. Comparative Example 1-3, which does not contain any lactone, but a monofunctional epoxy compound, shows a volume shrinkage being increased by 37.5% and 65% in relative numbers compared to Examples 1-1 and 1-2, respectively. Comparative Examples 1-1 and 1-2, containing 7- and 6-membered lactones, which are not condensed to aromatic or heteroaromatic moieties, still show a relative increase of volume shrinkage being 20.8 and 25.0%, respectively, in relative numbers compared to Example 1-1, and 45 and 50%, respectively, in relative numbers compared to Example 1-2.

The shrinkage values in Example 1-3 and Example 1-4 which are compiled in Table 1-2 are comparable to those in the Example 1-1 and Example 1-2. This supports that the DHCM-chemistry reveals excellent shrinkage suppression effects.

In further examples another test system was used:

### Example 1-5

### Formulation: Bis F-DGE+DHCM+EMI

Instead of Bis A-DGE in the example 1-1, Bis F-DGE was used. Molar ratio [epoxy group of Bis F-DGE]:[DHCM]:[EMI]=85:15:5. The corresponding tests were those carried out for Example 1-1. The corresponding data are listed in Table 1-3.

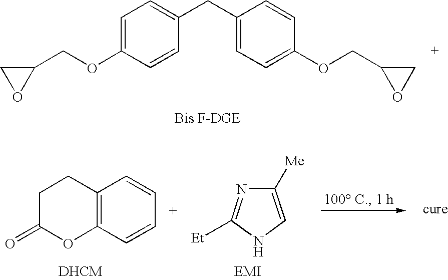

### Comparative 1-4

### Formulation: Bis F-DGE+GPE+EMI

Instead of Bis A-DGE in the comparative example 1-3, Bis F-DGE was used. Molar ratio [epoxy group of Bis F-DGE]:[epoxy group of GPE]:[EMI]=85:15:5. The corresponding tests were those carried out for the Example 1-1. The corresponding data are listed in Table 1-3.

TABLE 1-3
Properties of the curable formulations (cured at 100° C. for 1 h)

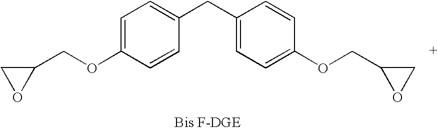

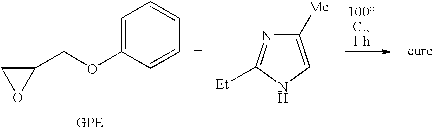

| | Example 1-5 | Comparative Example 1-4 |
|---|---|---|
| D_{before} (g/mL) | 1.189 | 1.175 |
| D_{after} (g/mL) | 1.229 | 1.233 |
| volume | 3.2 | 4.7 |
| shrinkage (%) | | |
| Td₁₀ | 415° C. | 415° C. |
| Tg | 120° C. | 99° C. |

This example 1-5 also supports that DHCM-chemistry has clear advantages over GPE.

### Example 2

BisA-DGE (8.93 g, 26.2 mmol, amount of epoxy group=52.4 mmol) and 3 (1.58 g, 6.80 mmol, amount of lactone group=13.6 mmol) were mixed with stirring and with evacuation. The mixture was heated at 100° C. to obtain a homogeneous mixture A (approximately 10 min). BisA-DGE (4.17 g, 12.2 mmol, amount of epoxy group=24.4 mmol) and EMI (0.55 g, 5.0 mmol; 4.5 mol % of [epoxy group]₀+[lactone group]₀) was mixed with stirring and with evacuation to obtain a mixture B. After cooling the mixture A to room temperature, the mixture B was added, and stirred with evacuation to obtain the adhesive composition as a homogeneous liquid. Curing reaction and shrinkage test were carried out as for Example 1-1.

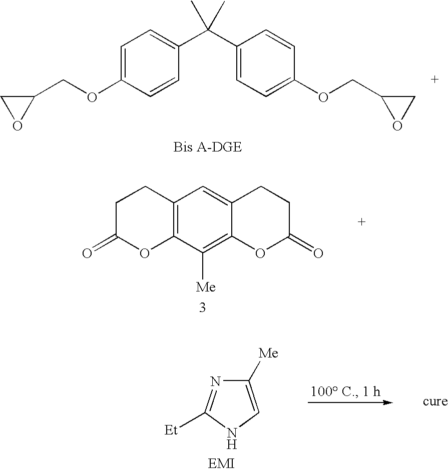

### Example 2-2

### Formulation: Bis A-DGE+m-Bis-DHCM+EMI

Instead of 3 in the Example 2, m-Bis-DHCM was used. Molar ratio [epoxy group]:[lactone group]:[EMI]=85:15:5. The corresponding tests were those carried out for the Example 2. The corresponding data are listed in Table 2.

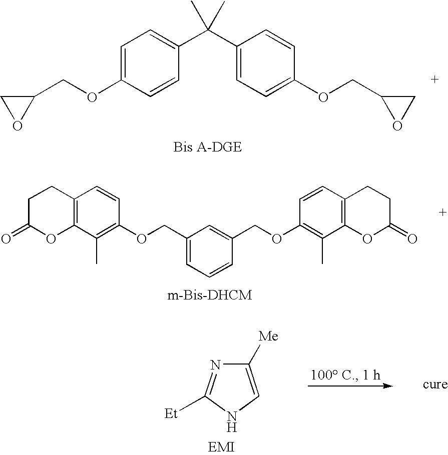

### Comparative 2

### Formulation: Bis A-DGE+EMI

No lactone and no monofunctional monomer were added. The ratio [epoxy group of Bis A-DGE]:[EMI]=100:5.

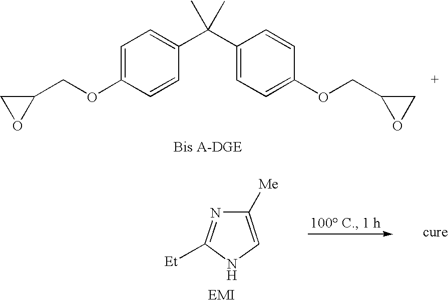

The data for Example 2 and Comparative Example 2 are listed in Table 2.

TABLE 2
Properties of the curable formulations (cured at 100° C. for 1 h)

| | Example 2 | Example 2-2 | Comparative Example 2 |
|---|---|---|---|
| D_{before} (g/mL) | 1.174 | 1.189 | 1.156 |
| D_{after} (g/mL) | 1.188 | 1.199 | 1.181 |
| volume | 1.2 | 0.82 | 2.2 |
| shrinkage (%) | | | |

Table 2 shows that the lack of the bifunctional lactone of the invention, i.e. its replacement by additional Bis A-DGE, results in an increased volume shrinkage being more than 83.3% higher (in relative numbers compared to Example 2).

### Example 3

### Formulation: Bis A-DGE+DHCM+Hx3921Hp

BisA-DGE (9.02 g; 45 wt.-%), DHCM (3.10 g; 15 wt.-%) and Hx3921Hp (which is an imidazol-based amine-hardener supplied by Asahi Kasei; 8.04 g; 40 wt.-%) were mixed and degassed under vacuum. The mixture was cured at 120° C. for 1 h. Shrinkage test and the other tests were carried out as for Example 1. Hx3921Hp is a standard curing reagent, which contains adducts of imidazole and epoxide, which are further encapsulated in epoxy resins.

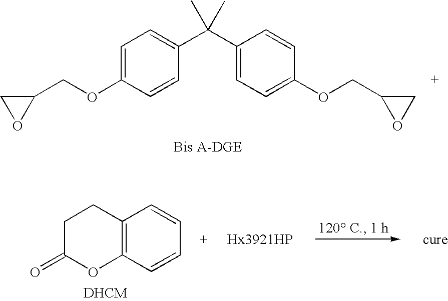

### Comparative Example 3

### Formulation: Bis A-DGE+GPE+Hx3921Hp

Instead of DHCM, the monofunctional epoxide GPE was used in a same weight ratio.

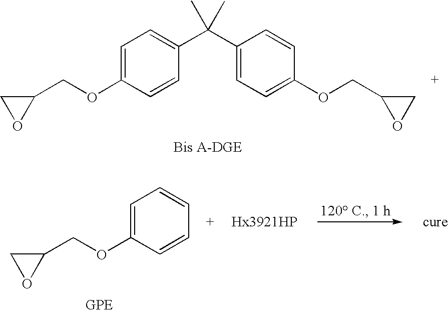

The data for Example 3 and Comparative Example 3 is listed in Table 3. This table shows that the lack, of DHCM in Comparative Example 3, i.e. its replacement by GPE, results in an increased volume shrinkage being 43.5% higher (in relative numbers compared to Example 3).

TABLE 3
Properties of the curable formulations (cured at 120° C. for 1 h)

| | Example 3 | Comparative Example 3 |
|---|---|---|
| D_{before} (g/mL) | 1.1784 | 1.1635 |
| D_{after} (g/mL) | 1.2056 | 1.2034 |
| volume | 2.3 | 3.3 |
| shrinkage (%) | | |
| Td₁₀ | 403° C. | 405° C. |
| Tg | 114° C. | 96° C. |

### Example 4-1

### Formulation: Bis A-DGE+DHCM+Jeffamine® 400, at 120° C.

BisA-DGE (17.0 g; 50 mmol), DHCM (2.7 g; 18 mmol) and Jeffamine® 400 (12.0 g; 30 mmol) were mixed and degassed under vacuum. The mixture was cured at 120° C. for 1 h. Shrinkage testing was carried out in the same way as described for Example 1.

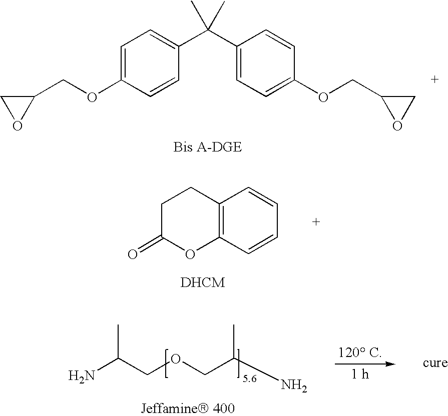

### Example 4-2

### Formulation: Bis A-DGE+DHCM+Jeffamine® 400, at 50° C.

The same formulation as for Example 4-1 was used and cured at 50° C. for 24 h.

### Example 4-3

### Formulation: Bis A-DGE+DHCM+Jeffamine® 400, at 50° C.

With using the same components as Example 4-1, a curable formulation with different feed ratio was prepared and cured. The curing conditions were the same as with example 4-2. Molar ratio [Bis A-DGE]:[DHCM]:[Jeffamine® 400]=100:15:57.5 mmol. Shrinkage testing was carried out in the same way as described for Example 1.

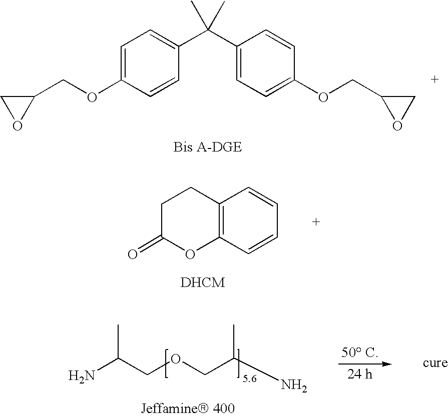

### Example 4-4

### Formulation: Bis A-DGE+bislactone 3+Jeffamine® 400, at 50° C.

Instead of DHCM in the Example 4-3, the bifunctional DHCM derivative 3 was used. Molar ratio [Bis A-DGE]:[lactone moiety of 3]:[Jeffamine® 400]=100:15:57.5 mmol. The curing conditions were the same as with Example 4-2. Shrinkage testing was carried out in the same way as described for Example 1.

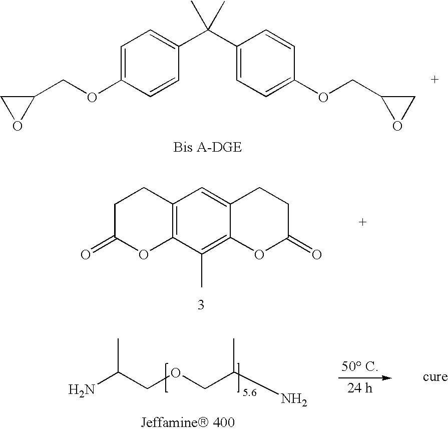

### Example 4-5

### Formulation: Bis A-DGE+bislactone 3+Jeffamine® 400, at 50° C.

With using the same components as Example 4-4, the feed molar ratio was varied to [Bis A-DGE]:[lactone moiety of 3]:[Jeffamine® 400]=100:30:65 mmol. The curing conditions were the same as with example 4-2. Shrinkage testing was carried out in the same way as described for Example 1.

### Comparative Example 4-1

### Formulation: Bis A-DGE+GPE+Jeffamine® 400, at 120° C.

Instead of DHCM, the monofunctional epoxide GPE was used in the same amount.

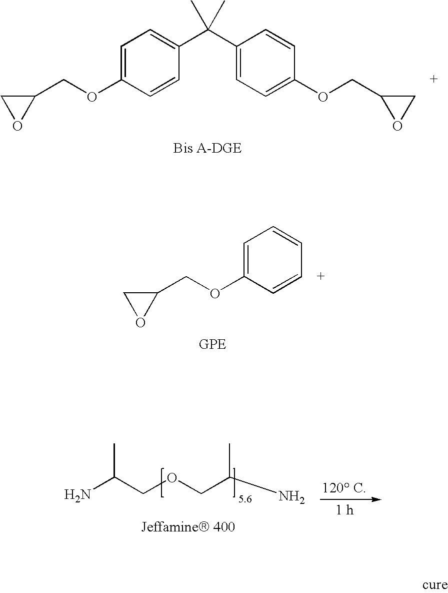

### Comparative Example 4-2

### Formulation: Bis A-DGE+GPE+Jeffamine® 400, at 50° C.

The same formulation as for the comparative example 4-1 was used and cured at 50° C. for 24 h.

### Comparative Example 4-3

No lactone was added. Molar ratio [Bis A-DGE]:[Jeffamine® 400]=100:50. The curing conditions were the same as with comparison example 4-2. The corresponding test results are listed in Table 4.

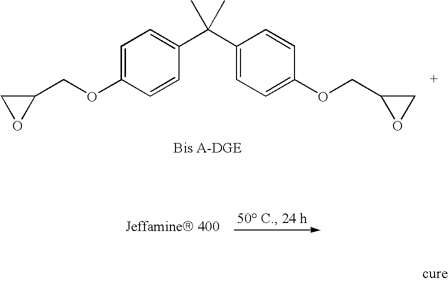

The data for Examples 4-1 to 4-5 and Comparative Examples 4-1 to 4-3 are listed in Table 4. This table shows that the lack of DHCM in the Comparative Examples or its replacement by GPE, results in significantly increased volume shrinkage.

TABLE 4
Properties of the curable formulations

| | | | | | | Com. Ex. | Com. Ex. | Com. Ex. |
|---|---|---|---|---|---|---|---|---|
| | Ex 4-1 | Ex 4-2 | Ex 4-3 | Ex 4-4 | Ex 4-5 | 4-1 | 4-2 | 4-3 |
| D_{before} (g/mL) | 1.096 | 1.096 | 1.089 | 1.100 | 1.109 | 1.077 | 1.077 | 1.080 |
| D_{after} (g/mL) | 1.137 | 1.132 | 1.140 | 1.149 | 1.151 | 1.136 | 1.132 | 1.143 |
| volume | 3.6 | 3.1 | 4.5 | 4.3 | 3.6 | 5.2 | 4.8 | 5.5 |
| shrinkage (%) | | | | | | | | |

These results support that DHCM derivatives exhibit their shrinkage suppression effect not only in epoxy-imidazole curing systems

### Example 5-1

### Formulation: Bis A-DGE+DHCM+Jeffamine® 400+EMI

To the formulation of Example 4-3, EMI was added. Molar ratio [Bis A-DGE]:[DHCM]:[Jeffamine® 400]:[EMI] is 100:15:57.5:3. Tests were carried out as for Example 1-1. The corresponding results are listed in Table 5.

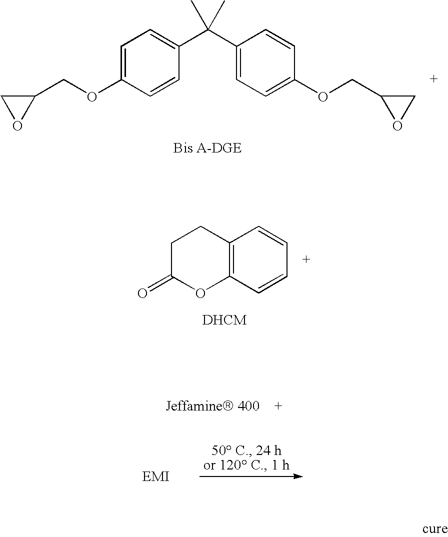

### Example 5-2

### Formulation: Bis A-DGE+DHCM+Jeffamine® 400+EMI

Using the same components as Example 5-1, the curing reaction was carried out with molar ratio [Bis A-DGE]:[DHCM]:[Jeffamine® 400]:[EMI]=100:30:65:3. Tests were carried out as for Example 1-1. The corresponding results are listed in Table 5.

### Example 5-3

### Formulation: Bis A-DGE+bislactone 3+Jeffamine® 400+EMI

To the formulation of Example 4-3, EMI was added. Molar ratio [Bis A-DGE]:[lactone moiety of 3]:[Jeffamine® 400]:[EMI]=100:15:57.5:3. The corresponding test results are listed in Table 5.

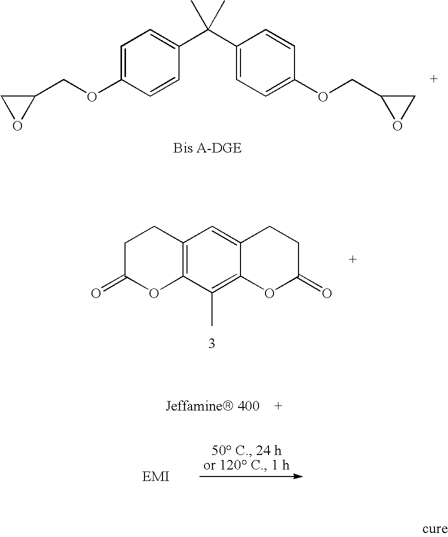

### Example 5-4

### Formulation: Bis A-DGE+bislactone 3+Jeffamine® 400+EMI

Using the same components as Example 5-1, the curing reaction was carried out with molar ratio [Bis A-DGE]:[lactone moiety of 3]:[Jeffamine® 400]:[EMI]=100:30:65:3. The corresponding results are listed in Table 5.

### Comparative Example 5-1

No lactone was added. The ratio [Bis A-DGE]:[Jeffamine® 400]:[EMI]=100:50:3. The corresponding test results are listed in Table 5.

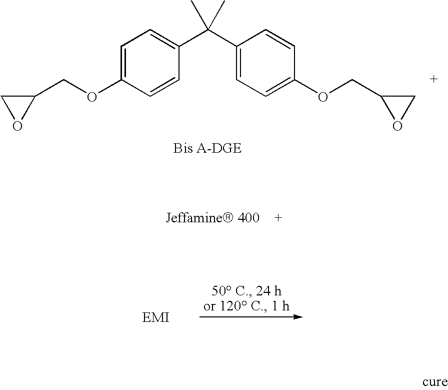

TABLE 5
Properties of the curable formulations.

| | | | | | | | | | Com. Ex. | |
|---|---|---|---|---|---|---|---|---|---|---|
| | Ex 5-1 | | Ex 5-2 | | Ex 5-3 | | Ex 5-4 | | 5-1 | |
| D_{before} (g/mL) | 1.089 | | 1.100 | | 1.100 | | 1.109 | | 1.081 | |
| D_{after} (g/mL) | 1.140 | (1.141) | 1.148 | (1.146) | 1.149 | (1.149) | 1.152 | (1.151) | 1.140 | (1.144) |
| volume | 4.5 | (4.5) | 4.2 | (4.0) | 4.3 | (4.3) | 3.7 | (3.6) | 5.2 | (5.5) |
| shrinkage (%) | | | | | | | | | | |
| Tg (° C.) | 26 | (25) | 24 | (24) | 30 | (29) | 30 | (33) | 41 | (45) |
| Td₅ (° C.) | 269 | (272) | 259 | (256) | 285 | (283) | 285 | (275) | 276 | (277) |

Curing conditions: At 50° C. for 24 h. The figures in the parentheses are those for the curing reactions at 120° C. for 1 h.

These results support that DHCM and its derivatives exhibits their shrinkage suppression effects in dual amine system.

Reduction of the curing temperature of amine-curing epoxy compositions of the present invention in the presence of primary and/or secondary amines as curing agents

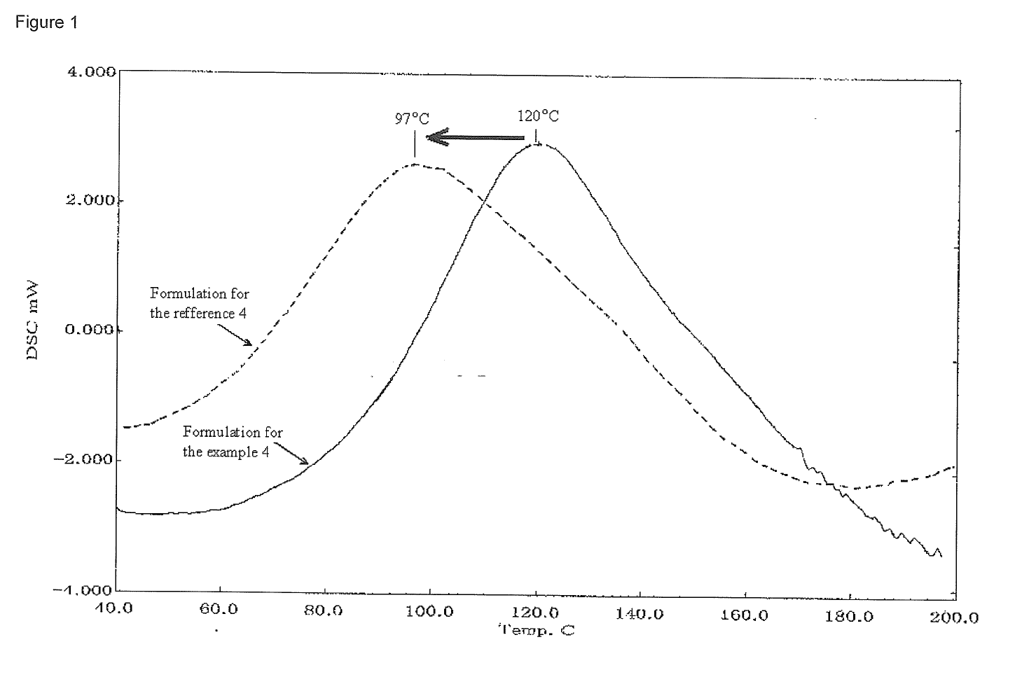

A further advantage of the addition of the lactones used in the present invention is that the curing temperature can be reduced, i.e. the curing process can be performed in an energy-saving way, if the amine-type hardener is a primary and/or secondary amine. FIG. 1 shows the differential scanning calorimetric profiles (DSC profiles) for the curing reactions of the formulations used in Example 4-1 and Comparative Example 4-1. By replacing GPE by DHCM, the temperature of the maximum exotherm decreased by 23° C.

What is claimed is:

1. A method for suppressing shrinkage in an amine-curing epoxy composition comprising at least one epoxy resin and at least one amine curative, said method comprising incorporating into said amine-curing epoxy composition at least one lactone compound comprising a 6-membered lactone ring which is condensed to an aromatic or heteroaromatic moiety and curing said amine-curing epoxy composition.

2. A method according to claim 1, wherein the aromatic or heteroaromatic moiety is a 6-membered ring.

3. A method according to claim 1, wherein the aromatic moiety is a benzene moiety.

4. A method according to claim 1, wherein the at least one lactone compound is selected from the group consisting of dihydrocoumarin and substituted dihydrocoumarins.

5. A method according to claim 1, wherein the aromatic or heteroaromatic moiety the 6-membered lactone ring is condensed to is a 5- to 7-membered aromatic or heteroaromatic ring, wherein the hetero atom or hetero atoms in the heteroaromatic ring are selected from the group consisting of nitrogen, oxygen or sulfur.

6. A method according to claim 1, wherein the 6-membered lactone ring is condensed to a benzene moiety as the aromatic moiety, and the at least one lactone compound is described by the following general formula (I): 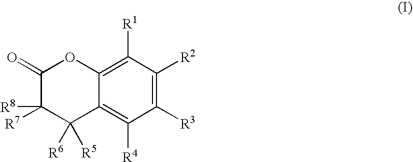
wherein R¹, R², R³, R⁴, R⁵, R⁶, R⁷ and R⁸ are independently same or different and denote
hydrogen;
a straight chain or branched alkyl group having 1 to 20 carbon atoms;
an aryl, alkaryl or aralkyl groups, which is directly bound to the aromatic or heteroaromatic moieties or 6-membered lactone moiety, or which is bound to those moieties by bridging atoms or bridging groups;
neighboring residues R¹ and R²1 or R² and R³; or R³ and R⁴ form 6-membered lactone moieties; and/or
one residue R¹, R², R³ or R⁴ is an aliphatic, cycloaliphatic or aromatic “bridging group” to a second lactone of general formula (I).

7. A method according to claim 6, wherein R⁵, R⁶, R⁷ and R⁸ are hydrogen and at least one of R¹, R², R³ or R⁴ is not hydrogen.

8. A method according to claim 1, wherein the epoxy resin is represented by general formula (II): 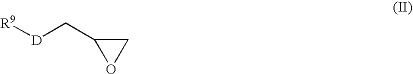
wherein D denotes an oxygen or 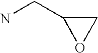
and R⁹ is selected from the group consisting of a straight-chain or branched alkyl group with 1 to 18 carbon atoms; an aromatic or heteroaromatic group with 4 to 12 carbon atoms; a group with the structure 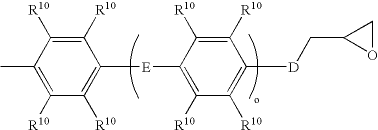
wherein all R¹⁰ within the group are same or different and independently denote hydrogen or an alkyl group with 1 to 4 carbon atoms; and
o is 0 or 1; and
E is selected from the group consisting of a carbon-carbon single bond and CR¹¹₂ wherein R¹¹ is same or different and independently denotes hydrogen or an alkyl group with 1 to 4 carbon atoms; and
D is 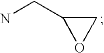
or
R⁹ is a group with the structure R¹²—SiR¹³R¹⁴R¹⁵
wherein R¹³ and R¹⁴ are the same or different, each of which denotes a straight-chain or branched alkoxy residue with 1 to 6 carbon atoms or an aryloxy or aralkyloxy residue,
R¹⁵ is different or the same as R¹³ or R¹⁴ or an aliphatic residue, an amino residue, a halogen residue, an aromatic or heteroaromatic residue, or an araliphatic or heteroaraliphatic residue,
R¹² is a bridging group selected from the group consisting of aliphatic, heteroaliphatic, araliphatic, heteroaraliphatic, aromatic and heteroaromatic groups.

9. A method according to claim 1, comprising one or more amine curatives selected from the group consisting of primary amines, secondary amines, and mixtures of one or more tertiary amines, one or more aromatic amines and one or more heteroaromatic amines.

10. A method according to claim 1, wherein said at least one amine curative is a mixture comprised of a) imidazole and/or an alkylated imidazole, a heterocyclic tertiary amine and c) a polyoxyalkyleneamine.

11. A method according to claim 1, wherein the molar ratios are as follows:
[epoxy groups (mol)]:[amine curative (mol)]=99.9:0.1 to 80:20; and
[epoxy groups (mol)]:[lactone groups (mol)]=99:1 to 30:70.

12. A method according to claim 1, wherein the molar ratios are as follows:
[epoxy groups (mol)]:[amine curative (mol)]=99:1 to 90:10; and
[epoxy groups (mol)]:[lactone groups (mol)]=95:5 to 60:40.

13. A method according to claim 1, wherein the molar ratios are as follows:
[epoxy groups (mol)]:[active hydrogen in primary and/or secondary amine groups (mol)]=90:10 to 30:70; and
[epoxy groups (mol)]:[lactone groups (mol)]=99:1 to 30:70.

14. A method according to claim 1, wherein the molar ratios are as follows:
[epoxy groups (mol)]:[active hydrogen in primary and/or secondary amine groups (mol)]=75:25 to 50:50; and
[epoxy groups (mol)]:[lactone groups (mol)]=95:5 to 60:40.

15. A method according to claim 1, wherein the at least one epoxy resin comprises 20% by weight to 100% by weight, based on the total epoxy component, of a multifunctional epoxy resin and up to 20% by weight of a monofunctional epoxy resin.

16. A method according to claim 1, additionally comprising applying said amine-curing epoxy composition to a substrate prior to curing said amine-curing epoxy composition.

17. A method according to claim 16, wherein said substrate is selected from the group consisting of metals, silicates, metal oxides, concrete, wood, electronic chip materials, semiconductor materials, and organic polymers.

18. A method according to claim 1, additionally comprising coating a substrate with said amine-curing epoxy composition prior to curing said amine-curing epoxy composition.

19. A method according to claim 1, additionally comprising applying said amine-curing epoxy composition between two substrates prior to curing said amine-curing epoxy composition.
